(19) United States
(12) Patent Application Publication
(10) Pub. No.: US 2013/0096820 A1
(43) Pub. Date: Apr. 18, 2013

(54) VIRTUAL DISPLAY SYSTEM FOR A VEHICLE

(71) Applicant: Continental Automotive Systems, Inc., Auburn Hills, MI (US)

(72) Inventor: David Leslie Agnew, Clarkston, MI (US)

(73) Assignee: CONTINENTAL AUTOMOTIVE SYSTEMS, INC., Auburn Hills, MI (US)

(21) Appl. No.: 13/622,438

(22) Filed: Sep. 19, 2012

Related U.S. Application Data
(60) Provisional application No. 61/547,374, filed on Oct. 14, 2011.

(51) Int. Cl. G01C 21/00

(52) U.S. Cl. 701/428

(57) ABSTRACT

A display system for a vehicle comprises display screens mounted within a passenger compartment of a vehicle. Cameras are mounted on the exterior of the vehicle corresponding to the positions of the display screens. A sensor(s) is directed toward a driver for the vehicle to sense a driver eye position. An ECU for the display system analyzes the driver eye position and determines a line of sight. An image from the camera is displayed on the display screen that corresponds to the driver's line of sight. Consequently, rather than the vehicle obstructing the driver's view the display system provides images to the driver of what would be seen if the vehicle body was not there. Thus, the display system provides virtually transparent portions of the vehicle body which widens the field of view provided to the driver.

### PRIORITY

This application is a non-provisional of, and claims priority to the Oct. 14, 2011, filing date of, U.S. provisional patent application Ser. No. 61/547,374, the entire content of which is incorporated herein by reference.

### TECHNICAL FIELD

The present disclosure relates to automotive vehicles, and more particularly to driver assistance devices for automotive vehicles.

### BACKGROUND

Mirrors are used to enhance the field of vision seen by a driver of a vehicle. The mirrors are used to allow the driver to view vehicles located behind and beside them. The mirrors are typically secured to the top-center of the windshield area and either side of the vehicle for convenience of the driver. However, the driver's vision is still obstructed at several locations by structural elements that cannot be removed from the vehicle, such as the pillars on either side of the windshield, and at “blind-spots” on either side of the vehicle that are out of range of the driver's direct vision and the mirrors in a standard mirror arrangement.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A display system for a vehicle comprises display screens mounted within a passenger compartment of a vehicle, such as on the pillars connecting the roof to the lower vehicle body. Cameras are mounted on the exterior of the vehicle to record images corresponding to the positions of the display screens. A sensor is directed toward a driver for the vehicle to sense a driver eye position. An ECU for the display system analyzes the driver eye position and determines a line of sight. An image from the camera is displayed on the display screen that corresponds to the driver's line of sight. Consequently, rather than the vehicle obstructing the driver's view the display system provides images to the driver of what would be seen if the vehicle body was not there. Thus, the display system provides virtually transparent portions of the vehicle body which widens the field of view provided to the driver.

A display system for a vehicle comprises a first display screen mounted to a first mounting position for the vehicle and an ECU controllably connected to the first display screen. A camera is mounted to the vehicle to provide images from outside of the vehicle. At least one sensor is located within the passenger compartment and directed toward a driver seat. A first image is displayed on the first display screen, wherein the first image is determined by the ECU based upon a predicted point of view of the driver using information from the at least one sensor.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle utilizing a display system of the present invention;

FIG. 2 is a schematic illustration of a driver view of the display system of the present invention;

FIG. 3 is a schematic illustration of a top view of a passenger compartment and the display system of the present invention;

FIG. 4 is a schematic illustration of a top view of an area surrounding the vehicle, the passenger compartment and the display system of the present invention; and

FIG. 5 is a schematic illustration of an arrangement and method for using the display system of the present invention.

### DETAILED DESCRIPTION

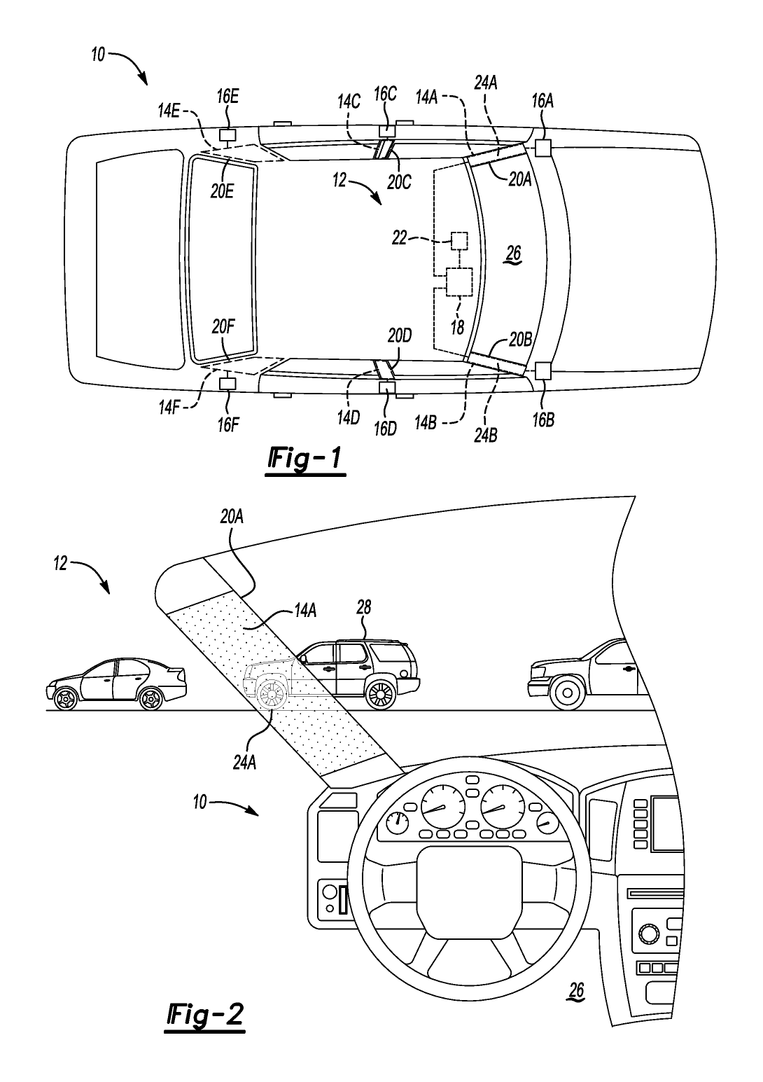

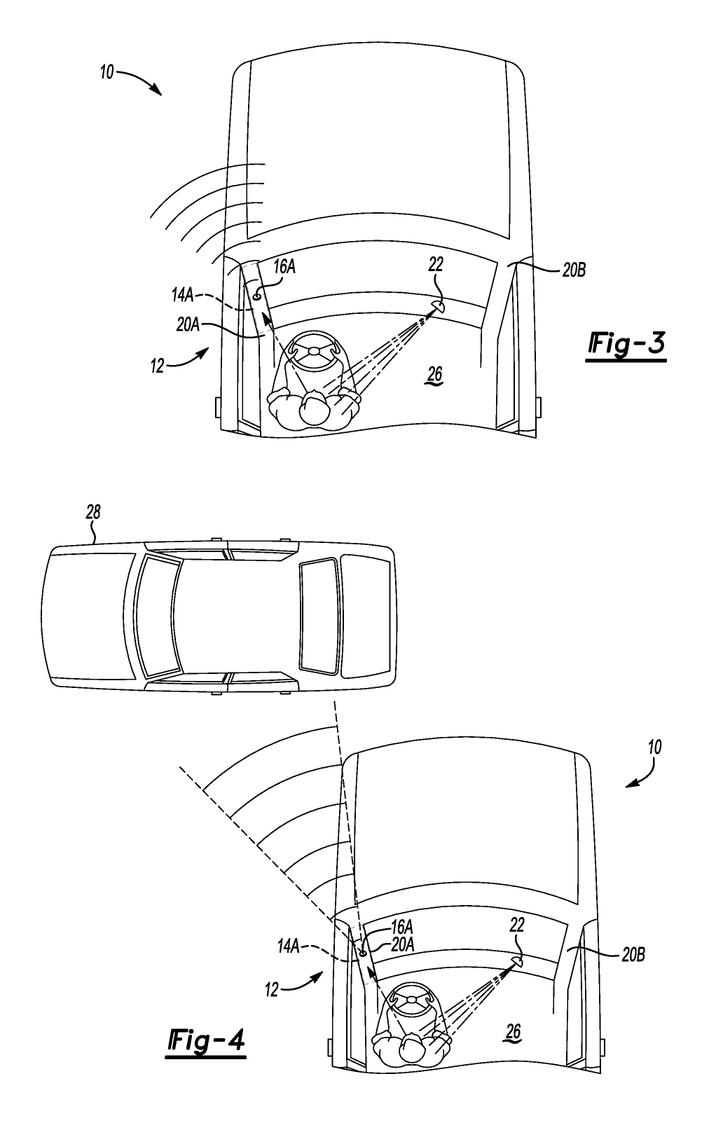

The following description is merely exemplary in nature and is in no way intended to limit the disclosure, its application, or uses. For purposes of clarity, the same reference numbers will be used in the drawings to identify similar elements. Throughout the application the relative directions such as forward and rear are in reference to the direction which a driver for the vehicle 10 would primarily be facing when operating the vehicle 10. FIG. 1 thru FIG. 3 illustrates a vehicle 10 and a display system 12 of the present invention. The display system 12 includes a plurality of display screens 14A-F mounted to a plurality of display mounting locations 20A-F on the vehicle 10. In the embodiment shown, the display mounting locations 20A, B are the A-pillars for the vehicle 10. The A-pillars are typically the vertical portions of the vehicle body which frame the windshield. The display screens 14A-F are connected to cameras 16A-F mounted to the vehicle 10 to display the moving, real-time images captured by the cameras 16A-F. The display screens 14A-F may be low density color screens, such as LCD screens

There is at least a first screen 14A mounted at a first mounting location 20A and a second screen 14B mounted at a second mounting location 20B. However, each display screen 14A-F may be a panel of multiple displays all mounted at that mounting locations 20A-F. The first mounting location 20A is one of the A-pillars and the second mounting location 20B is the other A-pillar.

The camera 16A-F and the display screens 14A-F are connected to an electronic control unit (ECU) 18 (not all connections shown) which controls the display screens 14A-F. In addition, at least one sensor 22 is located in the passenger compartment 26 and is directed toward a driver of the vehicle 10. The sensor 22 detects a driver's eye position to provide a three-dimensional location of the driver's eye position within the passenger compartment 26. For easier detection in all three dimensions multiple sensors 22 may be used. Therefore, the sensor 22 is preferably an array of sensors. The sensor 22 may be a low resolution camera, an ultrasonic sensor, or a combination of the like. The sensor 22 may be used by other systems within the vehicle 10 as well. For example, the sensor 22 may be a driver monitoring camera, or a sensor used by an occupant detection system.

The ECU 18 determines a driver head position and eye direction based upon the sensor 22. Using the three-dimension coordinates for the eye position the ECU 18 calculates the projected line of sight for the driver at that time. The ECU 18 calculates the driver's projected perspective through the mounting locations 20A-F of the display screens 14A-F. That is, the ECU 18 determines what the driver would be able to see if the vehicle 10 was not obstructing the view at that mounting location 20A-F. The ECU 18 then displays the moving images 24A-F (only one shown) captured by the cameras 16A-F on the display screens 14A-F which correspond to the projected perspective of the driver. The display screens 14A-F should have sufficient resolution to allow the driver to quickly see and understand what objects 28 are outside of the vehicle.

Rather than the vehicle 10 obstructing the driver's view at the mounting locations 20A-F the display system 12 provides images 24A-F to the driver of what would be seen if the vehicle 10 body was not there. Thus, the display system 12 provides virtually transparent portions of the vehicle 10 body at the mounting locations 20A-F which widens the field of view provided to the driver.

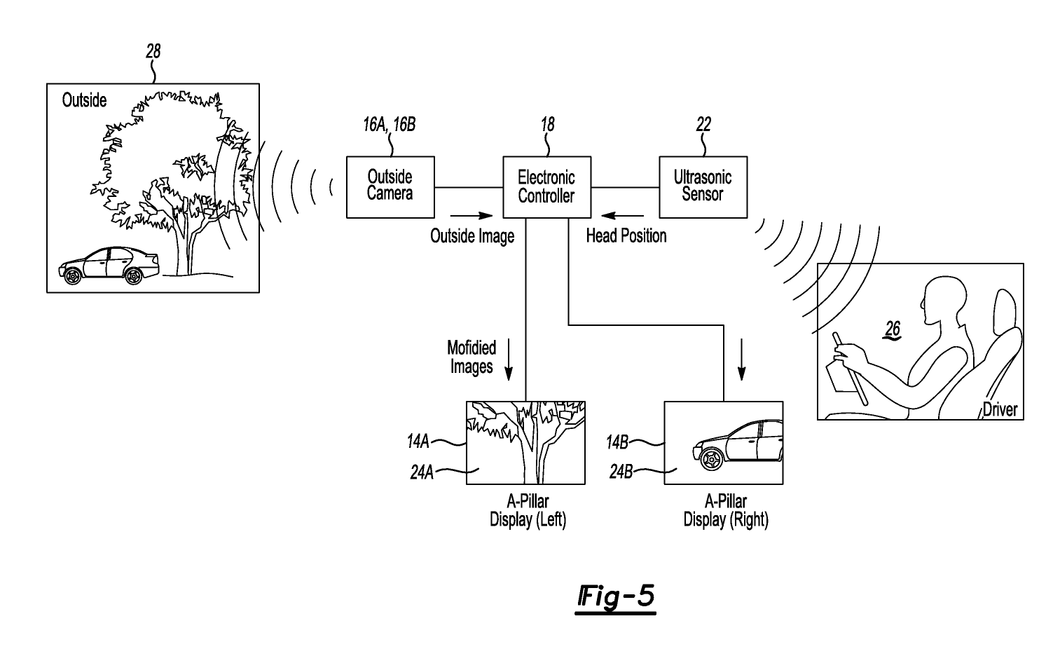

Referring to FIGS. 4 and 5, which illustrate the display screens 14A, B at the A-pillar locations only, as the driver moves while operating the vehicle the ECU 18 calculates and determines the new point of view and updates the images 24A, B shown on the display screens 14A, B to reflect the new point of view. For example, an object 28 outside of the vehicle 10 is recorded by one of the cameras 16A, B. In FIG. 4, the object is a car recoded by the first camera 16A. The ECU 18 calculates the driver's line of sight and displays the side of the car 28 on the display screen 14A while the rear corner may be visible through the windshield. However, as the driver shifts to the left the line of sight will shift. The ECU 18 calculates the new line of sight and displays the rear corner of the car 28 on the display screen 14A. Since the driver's head and line of sight are in constant motion the type of ECU 18 utilized should provide the fastest response time possible to minimize lag between the driver's head movement and the position of objects 26 outside of the vehicle. The ECU 18 may have a wired connection (shown in FIG. 1) with the cameras and the display screens 14A, B to minimize lag and provide quick response times. Additionally, as the number of display screens 14A-F increase multiple ECUs may be required to determine the driver's line of sight with respect to each display screen 14A-F.

While the embodiment above illustrates mounting locations 20A, B for the display screen 14A, B on the A-pillars other locations about the vehicle can utilize the display system 12. For example, display screens 14A-F may be mounted to provide views of typical “blind spot” areas, rear views, etc.

Referring back to FIGS. 1 thru 3, the cameras 16A-F are located on the exterior of the vehicle 10. The display screens 14A-F are located on the interior of the vehicle 10 at the mounting positions 20A-F and the cameras 16A-F are located on the exterior of the vehicle 10 at the mounting positions 20A-F. The cameras 16A-F are positioned to face outward from the vehicle 10 and record the area proximate to the vehicle 10. The cameras 16A-F should be positioned to provide a camera viewing angle similar to what the typical driver's line of sight will be from the driver's seat to that location. However, as explained above the driver's line of sight will vary as the driver moves. Additionally, different drivers will have different lines of sight and require different viewing angles for the cameras 16A-F. To accommodate the need for a range of viewing angles the cameras 16A-F may be fish-eye or wide angle cameras and record large sections of the area proximate to the vehicle 10 at that mounting position 20A-F. After the ECU 18 determines the lines of sight for the driver the ECU 18 will select a portion of the recorded image to show on the display screen 14A-F. The portion of the recorded image selected will be the portion that corresponds to that driver's line of sight. Different lines of sight will result in different portions of the recorded image being selected. The cameras 16A-F may have a fixed location to allow the ECU 18 to quickly process which portions of the recorded image correspond to the line of sight and select the image for the display screen 14A-F.

Alternatively, the cameras 16A-F may be moveably mounted to the vehicle 10. After the ECU 18 determines the line of sight the cameras 16A-F can be moved to record images that will correspond to that line of sight. The ECU 18 may control the camera to rotate or translate to obtain the correct viewing angle. Allowing for camera 16A-F movement may increase the number of viewing angles available. However, after the ECU 18 determines the lines of sight for the driver, and moves the camera 16A-F the ECU 18 may still need to use only a selected portions of the recorded image to show on the display screen 14A-F.

FIG. 5 illustrates a schematic diagram of the display system 12. The sensor 22 detects the position of a driver within the passenger compartment 26. The camera(s) 16A, 16B records an exterior area proximate to the vehicle 10. The information from the sensor(s) 22 and the camera(s) 16A, 16B are analyzed by the ECU 18. The ECU 18 determines the driver line of sights and shows the appropriate image 24A, 24B on the display screen 14A, 14B. The ECU 18 continually analyzes the driver's line of sight and updates the images at the vehicle 10 and driver are moving.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A display system for a vehicle comprising:
a first display screen mounted at a first mounting position for the vehicle to display a first image visible to a driver;
an electronic control unit controllably connected to the first display screen;
a camera mounted to the exterior of the vehicle to record an area proximate to the vehicle, wherein a recorded image is sent to the electronic control unit;
at least one sensor within the passenger compartment directed toward a driver seat to detect eye position of a driver, wherein the electronic control unit determines a predicted line of sight for the driver to the first display screen based upon the eye position; and
wherein electronic control unit selects the first image from the recorded image based upon a predicted line of sight of the driver.

2. The display system of claim 1, wherein the electronic control unit determines the first image displayed on the first display screen by one of: using a portion of the recorded image provided by the camera that relates to the predicted line of sight, and changing the camera viewing angle to provide a recorded image relating to the predicated line of sight.

3. The display system of claim 1, wherein the first mounting position is an A-pillar of the vehicle.

4. The display system of claim 1, wherein the at least one sensor is one of a camera and an ultrasonic sensor.

5. The display system of claim 1, wherein the first display screen is one of a low density color display screen and a plurality of low density color display screens mounted at the first mounting position.

6. The display system of claim 1, wherein the camera is a fish-eye camera.

7. A display system for a vehicle comprising:
a plurality of display screens mounted to a plurality of mounting positions on the vehicle to display a plurality of images visible to a driver;
at least one electronic control unit controllably connected to the plurality of display screens;
a plurality of cameras mounted to the exterior of the vehicle at the mounting positions to provide images from outside of the vehicle, wherein the mounting positions for the plurality of cameras corresponds to the mounting positions of the plurality of display screens;
a plurality of sensors within the passenger compartment directed toward a driver seat; and
a plurality of images displayed on the plurality of display screens, wherein the image on each of the plurality of display screens is determined by the electronic control unit using information from the at least one sensor based upon a predicted point of view of the driver for the each of the plurality of display screens.

8. The display system of claim 7, wherein the plurality of display screen mounting position is one of a driver side A-pillar, a passenger side A-pillar, and of the vehicle.

9. The display system of claim 7, wherein the plurality of sensors is one of a camera and at least one ultrasonic sensor; a plurality of ultrasonic sensors, and a plurality of cameras.

10. The display system of claim 7, wherein each of the plurality of display screens are one of a low density color display screen and a plurality of low density color display screens mounted at that mounting position of the plurality of display screens.

11. The display system of claim 7, wherein the plurality of cameras are fish-eye cameras.

12. The display system of claim 7, wherein the electronic control unit determines the image displayed on each of the corresponding plurality of display screens by one of: using a portion of the image provided by the corresponding one of the plurality of cameras that relates to the predicted point of view of the driver, and changing the viewing angle of the corresponding one of the plurality of cameras to provide images relating to the predicated point of view of the driver.

13. A method of displaying an image in vehicle comprising:
recording a first image of an area proximate to the vehicle with a camera mounted to the vehicle;
sensing eye position of a driver with at least one sensor located within a passenger compartment for the vehicle;
determining a line of sight for the driver based upon the eye position and corresponding to a position of a display screen mounted within passenger compartment of the vehicle and visible to the driver;
displaying a second image on the display screen, wherein the second image displayed corresponds to the line of sight the driver for the mounting position of the display screen.

14. The method of claim 13, wherein the second image is a portion of the first image selected based upon the eye position of the driver.

15. The method of claim 13, further comprising moving the camera to obtain a different point of view when recording the first image based upon the eye position of the driver and wherein the second image on the display screen is the same as the first image recorded by the camera.

16. The method of claim 13, wherein the first mounting position is an A-pillar of the vehicle.

17. The method of claim 13, wherein the at least one sensor is one of a camera and an ultrasonic sensor.
